(19) United States
(12) Patent Application Publication
(10) Pub. No.: US 2012/0014308 A1
(43) Pub. Date: Jan. 19, 2012

(54) METHODS AND APPARATUS TO SUPPORT RECONFIGURATION IN SELF ORGANIZED WIRELESS COMMUNICATIONS AND NETWORKS

(75) Inventors: Ying Li, Garland, TX (US); Zhouyue Pi, Allen, TX (US); Baowei Ji, Atlanta, GA (US); Jaehyuk Jang, Suwon-si (KR); Kaushik Josiam, Dallas, TX (US)

(73) Assignee: Samsung Electronics Co., Ltd., Suwon-si (KR)

(21) Appl. No.: 12/914,755

(22) Filed: Oct. 28, 2010

Related U.S. Application Data
(60) Provisional application No. 61/260,321, filed on Nov. 11, 2009.
(60) Provisional application No. 61/288,712, filed on Dec. 21, 2009.
(60) Provisional application No. 61/373,131, filed on Aug. 12, 2010.

(51) Int. Cl. H04W 72/04; H04W 4/06; H04B 7/14; H04W 36/08

(52) U.S. Cl. 370/312; 370/329; 370/331; 370/315

(57) ABSTRACT

Prior to a change in a configuration, such as a change to the carrier frequency, bandwidth, base station type, and so forth of the base station, the base station can inform a subscriber station to prepare for the reconfiguration by sending a message to the subscriber station. The message informs the subscriber station regarding the change in configuration and a timing regarding the change. The base station can command the subscriber station to handover to the serving base station with the new configuration or the subscriber station can choose to handover to the serving base station with the new configuration. The subscriber station can perform network reentry to the serving base station with the new configuration at the time of or after the new configuration is effective. A communication context between the stations can be maintained and the network reentry can be optimized by omitting one or more operation procedures.

### CROSS-REFERENCE TO RELATED APPLICATION(S) AND CLAIM OF PRIORITY

The present application is related to U.S. Provisional Patent Application Nos. 61/260,321, filed Nov. 11, 2009, entitled “METHODS AND APPARATUS TO SUPPORT RECONFIGURATION IN SELF ORGANIZED WIRELESS COMMUNICATIONS AND NETWORKS” and 61/288,712, filed Dec. 21, 2009, entitled “METHODS AND APPARATUS TO SUPPORT RECONFIGURATION IN SELF ORGANIZED WIRELESS COMMUNICATIONS AND NETWORKS” and 61/373,131, filed Aug. 12, 2010, entitled “METHODS AND APPARATUS TO SUPPORT RECONFIGURATION IN SELF ORGANIZED WIRELESS COMMUNICATIONS AND NETWORKS”. Provisional Patent Application Nos. 61/260,321; 61/288,712 AND 61/373,131 are assigned to the assignee of the present application and is hereby incorporated by reference into the present application as if fully set forth herein. The present application hereby claims priority under 35 U.S.C. §119(e) to U.S. Provisional Patent Application Nos. 61/260,321; 61/288,712 AND 61/373,131.

### TECHNICAL FIELD OF THE INVENTION

The present application relates generally to wireless communications and, more specifically, to a self-organized networks in a wireless communications system.

### BACKGROUND OF THE INVENTION

Self-organized networks (SON) are capable of performing self-optimization, self-configuration and self-healing. In self-optimization, a SON uses processed measurements to recommend and apply an updated set of radio resource management parameters, including antenna parameters, power settings, neighbor lists, and a range of radio resource management parameters. Self-configuration utilizes preconfigured parameters to employ a plug-n-play type operation. A SON can adjust various parameters to attempt to overcome a loss of coverage or capacity caused by an event.

Self-organized networks support reconfigurations of the system. For some configurations, such as cell type, bandwidth (BW), frequency allocation (FA) or carrier frequency, cell identifier (ID), and so forth, the reconfiguration may cause call-drops, or service discontinuity, if the mobile station (MS) is not aware of such changes and if MS is not prepared. Some reconfigurations, such as a femto base station changing its operating type to be a relay station, may require a restart of the system.

### SUMMARY OF THE INVENTION

A base station capable of communicating with a plurality of subscriber stations is provided. The base station includes a transmit path configured to transmit a message to at least one subscriber station. The base station also includes a controller coupled to the transmit path. The controller is configured to, prior to a change of at least one parameter, inform the at least one subscriber station regarding the change of the at least one parameter via the message. The message includes information regarding the change of the at least one parameter. The message is configured to enable the subscriber station to perform a re-entry.

A method for reconfiguring a base station is provided. The method includes, prior to changing a configuration of the base station, sending a message to at least one subscriber station. The message is configured to indicate a change to at least one parameter. The method also includes enabling the at least one subscriber station perform a network re-entry.

A subscriber station capable of communicating with a plurality of base stations is provided. The subscriber station includes a receiver configured to receive a plurality of messages from a base station. The subscriber station also includes a controller coupled to the receiver. The controller is configured to decode a message received prior to a change of at least one parameter of the base station. The message includes information regarding the change of the at least one parameter. The controller also is configured to obtain, from the message, the information regarding the change of the at least one parameter. The information is configured to enable the subscriber station to perform a network re-entry.

A method for operating a subscriber station is provided. The method includes, prior to changing a configuration of the base station, receiving a message from the base station. The message includes information regarding the change of the at least one parameter. The method also includes obtaining, from the message, the information regarding the change of the at least one parameter to enable the subscriber station to perform a network re-entry.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an exemplary wireless network, which transmits ACK/NACK messages according to an exemplary embodiment of the disclosure;

FIG. 2A illustrates a high-level diagram of an orthogonal frequency division multiple access transmit path according to an exemplary embodiment of the disclosure;

FIG. 2B illustrates a high-level diagram of an orthogonal frequency division multiple access receive path according to an exemplary embodiment of the disclosure;

FIG. 3 illustrates an exemplary wireless subscriber station according to embodiments of the present disclosure;

FIG. 4 illustrates a handover procedure according to embodiments of the present disclosure; and

FIG. 5 illustrates an operation for a femto base station to transition between a regular mode and a relay mode according to embodiments of the present disclosure.

### DETAILED DESCRIPTION OF THE INVENTION

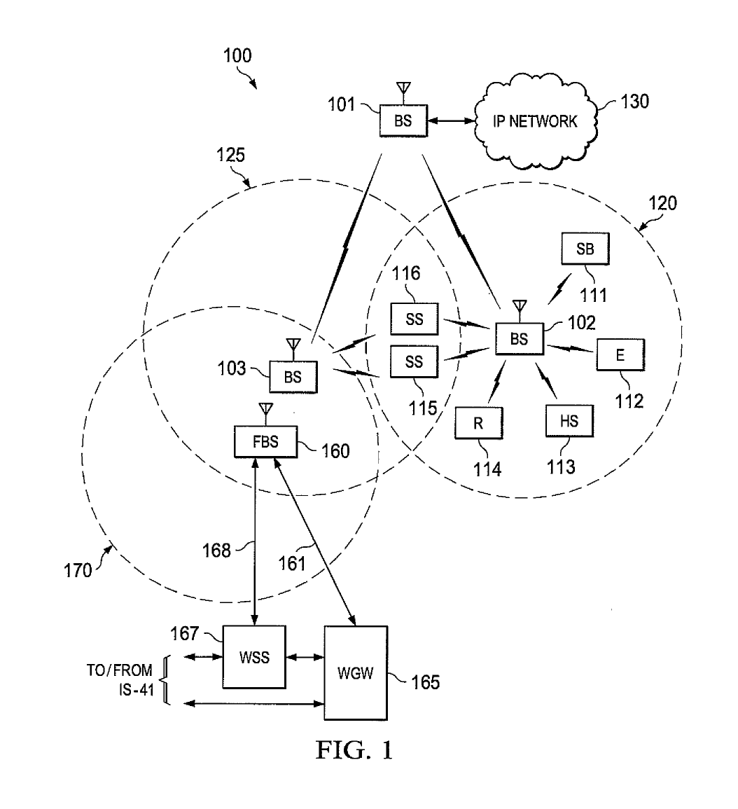

FIGS. 1 through 5, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged wireless communications network.

FIG. 1 illustrates an exemplary wireless network 100, which transmits ACK/NACK messages according to the principles of the present disclosure. In the illustrated embodiment, wireless network 100 includes base station (BS) 101, base station (BS) 102, base station (BS) 103, and other similar base stations (not shown). Base station 101 is in communication with base station 102 and base station 103. Base station 101 is also in communication with Internet 130 or a similar IP-based network (not shown).

Base station 102 provides wireless broadband access (via backhaul connection 131) to Internet 130 to a first plurality of subscriber stations within coverage area 120 of base station 102. The first plurality of subscriber stations includes subscriber station 111, which may be located in a small business (SB), subscriber station 112, which may be located in an enterprise (E), subscriber station 113, which may be located in a wireless fidelity (WiFi) hotspot (HS), subscriber station 114, which may be located in a first residence (R), subscriber station 115, which may be located in a second residence (R), and subscriber station 116, which may be a mobile device (M), such as a cell phone, a wireless laptop, a wireless PDA, or the like.

Base station 103 provides wireless broadband access (via a backhaul connection (not shown) or via base station 101 as a relay) to Internet 130 to a second plurality of subscriber stations within coverage area 125 of base station 103. The second plurality of subscriber stations includes subscriber station 115 and subscriber station 116. In an exemplary embodiment, base stations 101-103 may communicate with each other and with subscriber stations 111-116 using orthogonal frequency division multiplexing (OFDM) or orthogonal frequency division multiple access (OFDMA) techniques.

Base station 101 may be in communication with either a greater number or a lesser number of base stations. Furthermore, while only six subscriber stations are depicted in FIG. 1, it is understood that wireless network 100 may provide wireless broadband access to additional subscriber stations. It is noted that subscriber station 115 and subscriber station 116 are located on the edges of both coverage area 120 and coverage area 125. Subscriber station 115 and subscriber station 116 each communicate with both base station 102 and base station 103 and may be said to be operating in handoff mode, as known to those of skill in the art.

Subscriber stations 111-116 may access voice, data, video, video conferencing, and/or other broadband services via Internet 130. In an exemplary embodiment, one or more of subscriber stations 111-116 may be associated with an access point (AP) of a WiFi WLAN. Subscriber station 116 may be any of a number of mobile devices, including a wireless-enabled laptop computer, personal data assistant, notebook, handheld device, or other wireless-enabled device. Subscriber stations 114 and 115 may be, for example, a wireless-enabled personal computer (PC), a laptop computer, a gateway, or another device.

In some embodiments, the wireless network 100 includes a Femto-cell base station (FBS) 160. FBS 160 includes components analogous to those found in macro base stations BS 101, BS 102 and BS 103. As such, FBS 160 comprises a femto base station controller (FBSC) and one or more femto base transceiver subsystem(s) (FBTS) FBS 160 communicates with mobile stations in its served area using OFDMA, IS-95, CDMA or any other cellular communications standard.

Voice bearer traffic is transferred between the FBS 160 and the IS-41 network (e.g., PSTN) via communication line 161, Wireless Gateway (WGW) 165. Signaling/control traffic are transferred between the FBS 160 and the IS-41 network via communication line 168 and Wireless Soft Switch (WSS) 167. The WGW 165 and WSS 167 are coupled via a backhaul connection (not shown), e.g., the IS-41, to the MSC 140. The WGW 165 provides a bearer path between FBS 160 and MSC 140 via the IS-41. The WSS 167 provides a signaling path FBS 160 and WGW 165 as well as to the MSC 140 via the IS-41.

A dotted line shows the approximate boundary of cell 170 in which FBS 160 is located. The cell is shown approximately circular for the purposes of illustration and explanation only. It should be clearly understood that the cell may have an irregular shape, depending on the cell configuration selected and natural and man-made obstructions.

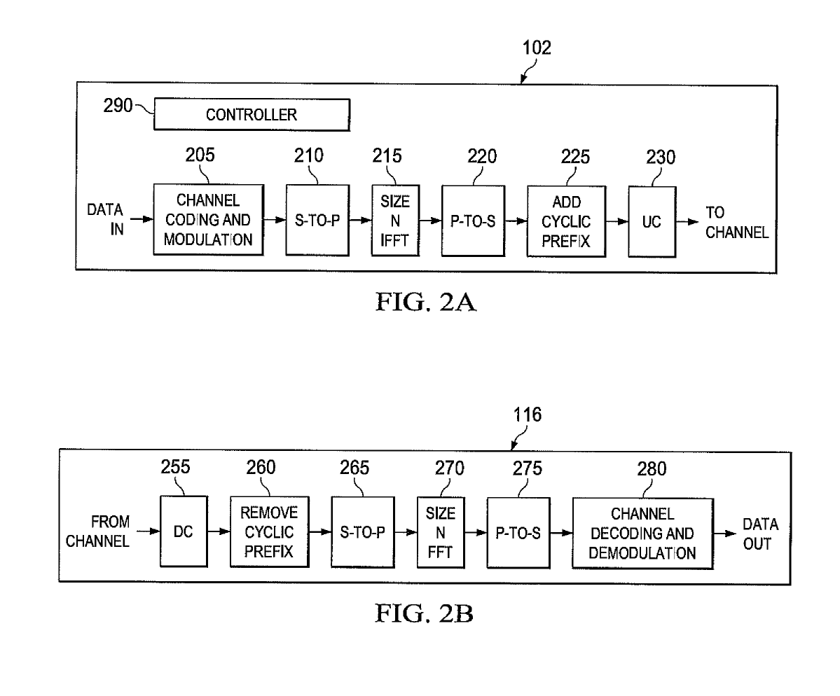

FIG. 2A is a high-level diagram of an orthogonal frequency division multiple access (OFDMA) transmit path. FIG. 2B is a high-level diagram of an orthogonal frequency division multiple access (OFDMA) receive path. In FIGS. 2A and 2B, the OFDMA transmit path is implemented in base station (BS) 102 and the OFDMA receive path is implemented in subscriber station (SS) 116 for the purposes of illustration and explanation only. However, it will be understood by those skilled in the art that the OFDMA receive path may also be implemented in BS 102 and the OFDMA transmit path may be implemented in SS 116.

The transmit path in BS 102 comprises channel coding and modulation block 205, serial-to-parallel (S-to-P) block 210, Size N Inverse Fast Fourier Transform (IFFT) block 215, parallel-to-serial (P-to-S) block 220, add cyclic prefix block 225, up-converter (UC) 230. The receive path in SS 116 comprises down-converter (DC) 255, remove cyclic prefix block 260, serial-to-parallel (S-to-P) block 265, Size N Fast Fourier Transform (FFT) block 270, parallel-to-serial (P-to-S) block 275, channel decoding and demodulation block 280.

At least some of the components in FIGS. 2A and 2B may be implemented in software while other components may be implemented by configurable hardware or a mixture of software and configurable hardware. In particular, it is noted that the FFT blocks and the IFFT blocks described in this disclosure document may be implemented as configurable software algorithms, where the value of Size N may be modified according to the implementation.

Furthermore, although this disclosure is directed to an embodiment that implements the Fast Fourier Transform and the Inverse Fast Fourier Transform, this is by way of illustration only and should not be construed to limit the scope of the disclosure. It will be appreciated that in an alternate embodiment of the disclosure, the Fast Fourier Transform functions and the Inverse Fast Fourier Transform functions may easily be replaced by Discrete Fourier Transform (DFT) functions and Inverse Discrete Fourier Transform (IDFT) functions, respectively. It will be appreciated that for DFT and IDFT functions, the value of the N variable may be any integer number (i.e., 1, 2, 3, 4, etc.), while for FFT and IFFT functions, the value of the N variable may be any integer number that is a power of two (i.e., 1, 2, 4, 8, 16, etc.).

In BS 102, channel coding and modulation block 205 receives a set of information bits, applies coding (e.g., LDPC coding) and modulates (e.g., QPSK, QAM) the input bits to produce a sequence of frequency-domain modulation symbols. Serial-to-parallel block 210 converts (i.e., de-multiplexes) the serial modulated symbols to parallel data to produce N parallel symbol streams where N is the IFFT/FFT size used in BS 102 and SS 116. Size N IFFT block 215 then performs an IFFT operation on the N parallel symbol streams to produce time-domain output signals. Parallel-to-serial block 220 converts (i.e., multiplexes) the parallel time-domain output symbols from Size N IFFT block 215 to produce a serial time-domain signal. Add cyclic prefix block 225 then inserts a cyclic prefix to the time-domain signal. Finally, up-converter (UC) 230 modulates (i.e., up-converts) the output of add cyclic prefix block 225 to RF frequency for transmission via a wireless channel. The signal may also be filtered at baseband before conversion to RF frequency.

The transmitted RF signal arrives at SS 116 after passing through the wireless channel and reverse operations to those at BS 102 are performed. Down-converter (DC) 255 down-converts the received signal to baseband frequency and remove cyclic prefix block 260 removes the cyclic prefix to produce the serial time-domain baseband signal. Serial-to-parallel block 265 converts the time-domain baseband signal to parallel time domain signals. Size N FFT block 270 then performs an FFT algorithm to produce N parallel frequency-domain signals. Parallel-to-serial block 275 converts the parallel frequency-domain signals to a sequence of modulated data symbols. Channel decoding and demodulation block 280 demodulates and then decodes the modulated symbols to recover the original input data stream.

BS 102 and FBS 160 can each include a base station controller (BSC) 290 coupled to the transmit path and receive path. BSC 290 manages the resources in the cell site, such as cell site 121. BCS 290 also includes a handoff controller. The embodiment of handoff controller included in BCS 290 is for illustration only and the handoff controller and a memory can be located in other portions of BS 102 without departing from the scope of this disclosure.

Each of base stations 101-103 and 160 may implement a transmit path that is analogous to transmitting in the downlink to subscriber stations 111-116 and may implement a receive path that is analogous to receiving in the uplink from subscriber stations 111-116. Similarly, each one of subscriber stations 111-116 may implement a transmit path corresponding to the architecture for transmitting in the uplink to base stations 101-103 and may implement a receive path corresponding to the architecture for receiving in the downlink from base stations 101-103.

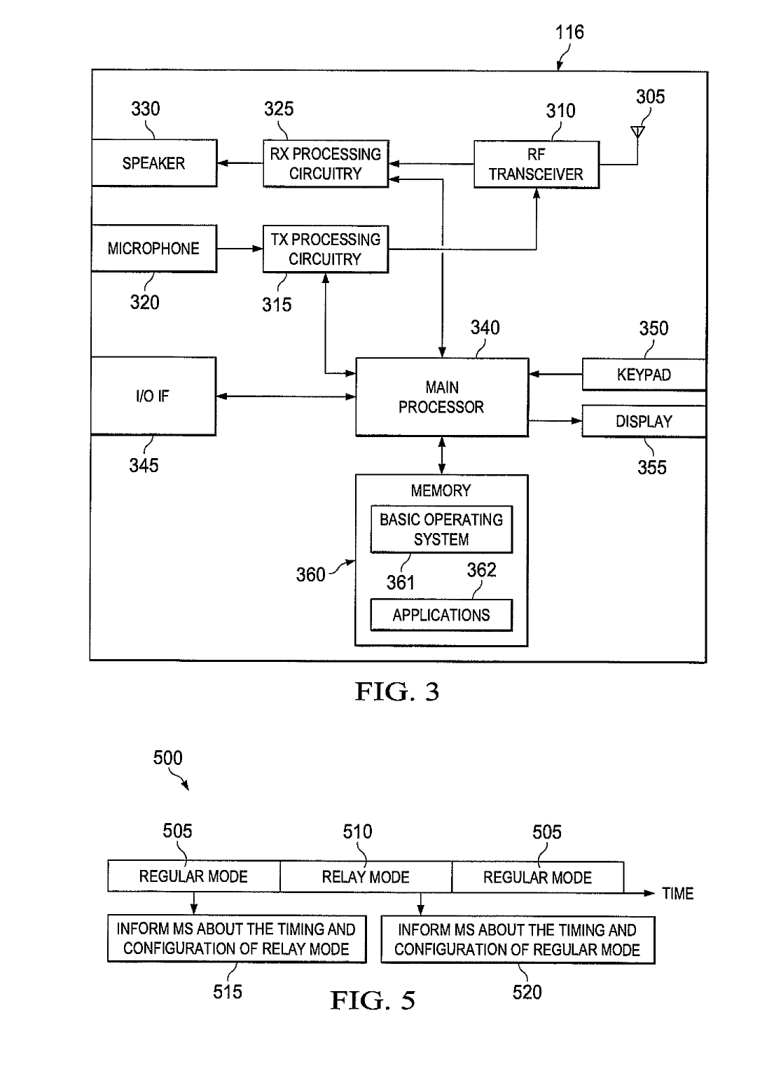

FIG. 3 illustrates an exemplary wireless subscriber station according to embodiments of the present disclosure. The embodiment of wireless subscriber station 116 illustrated in FIG. 3 is for illustration only. Other embodiments of the wireless subscriber station 116 could be used without departing from the scope of this disclosure.

Wireless subscriber station 116 comprises antenna 305, radio frequency (RF) transceiver 310, transmit (TX) processing circuitry 315, microphone 320, and receive (RX) processing circuitry 325. SS 116 also comprises speaker 330, main processor 340, input/output (I/O) interface (IF) 345, keypad 350, display 355, and memory 360. Memory 360 further comprises basic operating system (OS) program 361 and a plurality of applications 362.

Radio frequency (RF) transceiver 310 receives from antenna 305 an incoming RF signal transmitted by a base station of wireless network 100. Radio frequency (RF) transceiver 310 down-converts the incoming RF signal to produce an intermediate frequency (IF) or a baseband signal. The IF or baseband signal is sent to receiver (RX) processing circuitry 325 that produces a processed baseband signal by filtering, decoding, and/or digitizing the baseband or IF signal. Receiver (RX) processing circuitry 325 transmits the processed baseband signal to speaker 330 (i.e., voice data) or to main processor 340 for further processing (e.g., web browsing).

Transmitter (TX) processing circuitry 315 receives analog or digital voice data from microphone 320 or other outgoing baseband data (e.g., web data, e-mail, interactive video game data) from main processor 340. Transmitter (TX) processing circuitry 315 encodes, multiplexes, and/or digitizes the outgoing baseband data to produce a processed baseband or IF signal. Radio frequency (RF) transceiver 310 receives the outgoing processed baseband or IF signal from transmitter (TX) processing circuitry 315. Radio frequency (RF) transceiver 310 up-converts the baseband or IF signal to a radio frequency (RF) signal that is transmitted via antenna 305.

In some embodiments of the present disclosure, main processor 340 is a microprocessor or microcontroller. Memory 360 is coupled to main processor 340. According to some embodiments of the present disclosure, part of memory 360 comprises a random access memory (RAM) and another part of memory 360 comprises a Flash memory, which acts as a read-only memory (ROM).

Main processor 340 executes basic operating system (OS) program 361 stored in memory 360 in order to control the overall operation of wireless subscriber station 116. In one such operation, main processor 340 controls the reception of forward channel signals and the transmission of reverse channel signals by radio frequency (RF) transceiver 310, receiver (RX) processing circuitry 325, and transmitter (TX) processing circuitry 315, in accordance with well-known principles.

Main processor 340 is capable of executing other processes and programs resident in memory 360, such as operations for CoMP communications and MU-MIMO communications. Main processor 340 can move data into or out of memory 360, as required by an executing process. In some embodiments, the main processor 340 is configured to execute a plurality of applications 362, such as applications for CoMP communications and MU-MIMO communications. The main processor 340 can operate the plurality of applications 362 based on OS program 361 or in response to a signal received from BS 102. Main processor 340 is also coupled to I/O interface 345. I/O interface 345 provides subscriber station 116 with the ability to connect to other devices such as laptop computers and handheld computers. I/O interface 345 is the communication path between these accessories and main controller 340.

Main processor 340 is also coupled to keypad 350 and display unit 355. The operator of subscriber station 116 uses keypad 350 to enter data into subscriber station 116. Display 355 may be a liquid crystal display capable of rendering text and/or at least limited graphics from web sites. Alternate embodiments may use other types of displays.

Embodiments of the present disclosure support reconfiguration in self-organized wireless communications networks. The SON operation is discussed in, “IEEE C802.16m-09/2104r1,” Proposed AWD text for SON, September 2009; IEEE P802.16m/D2, “Draft amendment for IEEE 802.16m,” October 2009 the contents of each are incorporated by reference. In addition, PCT Patent Application WO/2009/022975 entitled “AUTOMATED AND SEAMLESS CHANGE OF REPORTING CELL IDENTITY”, the contents of which are incorporated by reference in their entirety, illustrates a message which contains the new cell ID/preamble and its effective timing should be sent to MS, so that the MS can know it in advance, not to interrupt the service. However, the message in WO/2009/022975 is limited to the cell ID.

BS 102 may need to reconfigure different configurations and parameters, and so forth, in different time scales (e.g., at different times), because of time-varying environment, working conditions, service requirements, and so forth. For example, BS 102 may change frequency allocation for interference avoidance/mitigation and the like. Additionally, FBS 160 can include a secondary backhaul, to enhance the reliability and flexibility of adjusting FBS 160 in a different environment. For example, together with the backhaul, such as cable or DSL, FBS 160 can include a backup wireless backhaul, such as a relay station. Therefore, FBS 160 may need to change from regular mode to relay mode, or vice versa.

However, some of the re-configurations may cause the service discontinuity for SS 116, if the changes due to the reconfigurations occur suddenly. Embodiments of the present disclosure provide a system and method to provide good service continuity when BS 102 performs reconfigurations, such as base station type, bandwidth, frequency allocation/carrier changes, and so forth. In addition, for the reconfigurations for different configurations and parameters, the detailed operations and procedures at the base stations and the network, or at the mobile stations, can be different and need to be specified in detail. For example, for certain reconfiguration on the physical layer such as frequency allocation change or other configuration change, the following questions need to be answered: whether the multiple access control can be kept or changed; which operations would be affected or changed; whether there are optimized way to enable the reconfiguration by using some simplified procedures or operations, and so forth. In this disclosure, the detailed operations and procedures to enable system reconfigurations are disclosed.

It will be understood that although examples herein may refer to a specific communication standard, such as by terms aligned with an IEEE 802.16m system, embodiments of the present disclosure are not limited in IEEE 802.16m system, and can be used in any communication system and network, with the terms referred to by different names. The following are some examples. Mobile station (MS) or Advanced mobile station (AMS) are meant to refer the subscriber station. Base station (BS) or Advanced base station (ABS) are meant to refer the base station. Cell ID or Preamble refers the physical level identifier of the base station, usually conveyed in synchronization channel. The cell ID could be reused within a type of base station. Frequency allocation (FA), or carrier frequency, refers the frequency carrier (spectrum) used by a base station. Handover (HO) refers that an MS is handed over to a serving BS to a targeting BS. Handover command (HO-CMD) refers a message used to notify MS how/when to handover. Base station identifier (BSID) refers a globally unique identifier of the base station. Super frame header (SFH) is part of the broadcast channel (BCH). SFH contains most important system information. Advanced air interface (AAI) may be used as the prefix of some control messages, and they are interchangeable to those messages without such prefix.

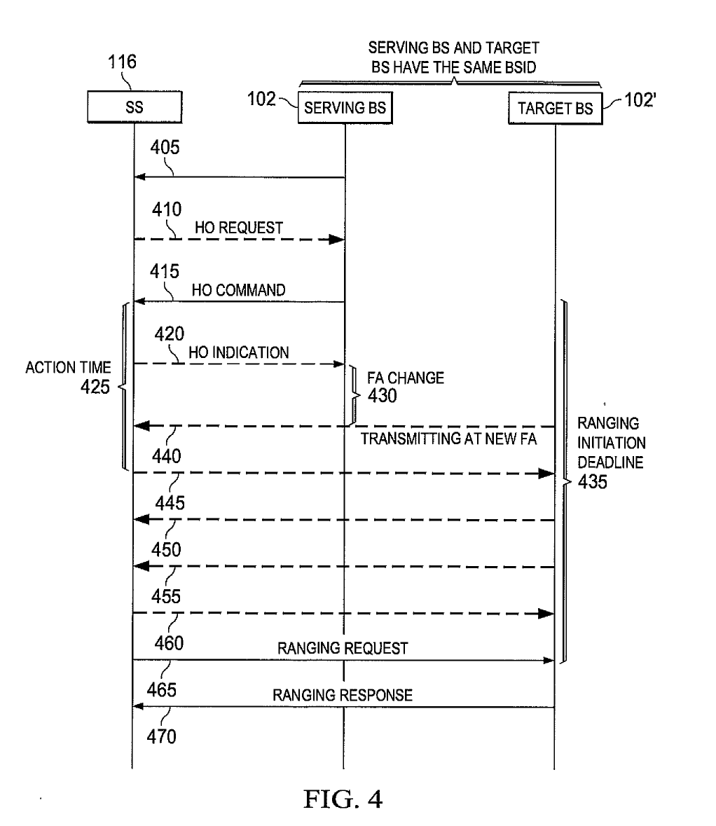

FIG. 4 illustrates a handover procedure according to embodiments of the present disclosure. The embodiment of the handover procedure shown in FIG. 4 is for illustration only. Other embodiments could be used without departing from the scope of this disclosure.

In some embodiments, BS 102 sends information regarding a new configuration and timing information for the reconfiguration to SS 116. The new configuration can include a change in bandwidth, frequency allocation (FA), or carrier frequency, or the like. The timing information can include an effective time of the new configuration, an in-between time interval that occurs between the current configuration and the new configuration. The in-between time interval may become an unavailable interval for SS 116 to access or scan for BS 102 since BS 102 transitioning from the current configuration to the new configuration. For example, when the new configuration involves an FA change, the in-between time interval can include a transition time interval for reconfiguration while SS 116 has a physical layer change but the MAC and upper layers (such as the connections at MAC layer, station ID, and so forth) could remain the same (such as in connected state, or idle mode, and so forth). In the transition time interval of BS 102 due to some physical layer reconfiguration, SS 116 may not be able to reach BS 102 at the physical layer and BS 102 may become unavailable for SS 116 to reach or access it at the physical layer.

In some embodiments, the configuration and timing information can be included in an existing message. In some embodiments, a new message can be generated to include the configuration and timing message. The information can be broadcasted, multicasted or unicasted. For example, the configuration and timing information can be in a SON advertisement message, such as SON-ADV message.

The timing information for the reconfiguration can also be an ending time of the current configuration. Additionally, the timing information can include an interval from the ending time of the current configuration to a beginning of the new configuration, and so forth.

During the transition time interval of the current and new configurations, for some reconfiguration types, such as FA change, bandwidth change, and the like, SS 116 may not be able to communicate with BS 102 at the physical layer, while the connection may be maintained on the MAC or higher layer.

Upon receiving the configuration and timing information, SS 116 can request a handover to another base station, such as BS 103. In addition, SS 116 can request a handover to BS 102 (that is, the serving base station) in accordance with the new configuration, such as a new bandwidth, new FA if FA is reconfigured, and the like. SS 116 can monitor BS 102 with the new configuration based on the effective time of the new configuration. SS 116 can make a choice based on the ongoing traffic type, latency/delay requirement of the data/voice traffic, signal strength from other base stations, such as BS 103, and so forth. For example, if SS 116 is experiencing voice traffic and cannot wait for a time indicated by the effective time of the new configuration, SS 116 can try to handover to BS 103, as opposed to BS 102 with the new configuration.

If BS 102 needs to change one configuration, some follow up reconfigurations may be needed. These follow up reconfigurations also need to be communicated to SS 116. For example, if BS 102 needs to change FA (the FA change could be decided by BS 102, indicated by a SON server, or through a backhaul connection, such as by other base stations), BS 102 may also check whether the preamble or cell ID should be changed. BS 102 can check by itself or request that the SON server or backhaul check whether the preamble or cell ID should be changed. If the cell ID also needs to be changed, then a new cell ID also can be sent to SS 116 in the configuration and timing information. For another example, if the type of BS 102 changes, the frame structure may also need to be changed, hence, the information on the new frame structure may need to be informed to SS 116.

If BS 102 needs to change FA, BS 102 can add itself with this new FA into the neighbor list. For example, BS 102 can include BS 102 with the new FA in the neighbor advertisement message, and add an effective timing for the new FA. Upon receiving the configuration and timing information, SS 116 can request a handover to BS 102 at the new FA based on the neighbor list.

In some embodiments, when SS 116 requests a handover to BS 102 (the serving base station itself) at the new FA, SS 116 performs a simplified handover. It will be understood that although an FA change is discussed as an example, the reconfiguration can be any kind of any base station re-configuration, such as frequency allocation change, BW change, base station type change, and the like without departing from the scope of this disclosure.

In some embodiments, before BS 102 changes its FA, BS 102 commands SS 116, which is within a coverage for BS 102, to handover to BS 102 at the new FA. The MAC context (such as the station ID, connection ID, basic capability context, security context (e.g., PKM keys, and so forth), and the like) remains the same. The MAC context can remain the same to enable the simplified network re-entry of SS 116. BS 102 can inform SS 116 regarding the new FA and the new cell ID if applicable (as the target BS FA, target BS cell ID) in the handover command, and instruct SS 116 to re-enter the target base station (that is, BS 102 as the serving BS itself but at the new FA) after the FA is changed. For example, BS 102 can instruct SS 116 to re-enter BS 102 by setting the re-entry time or the re-entry action time in the handover command to be no sooner than the effective time of new FA.

In the handover command, a special handover mode indicator (SHOMI) can be included to indicate the special HO mode, which is the mode to handover BS 102 at the old configuration to BS 102 at the new configuration. By including the SHOMI in the handover command, the target BSID could be omitted from the handover command since the target BSID is the same as the serving BSID, that is, both the target BSID and serving BSID are the BSID for BS 102. The SHOMI can be jointly coded with the other indications in the handover command.

The handover command also can include a simplified re-entry indicator (SRI) configured to indicate that the network re-entry can be simplified. For example, the SRI can be configured to indicate that the ranging process or the random access can be skipped (e.g. ‘1’ Not skip; ‘0’ Skip). The SRI can be configured to indicate that the ranging process can be simplified as just a simple handshake, such as only one indication of such ranging with a ranging purpose bit specially set in the ranging request message (such as ranging request message only contains a purpose bit to indicate this is simplified ranging). The SRI can be configured to indicate that the ranging response can be only an indication of whether the ranging request is received or not. For example, the handover command can include one SRI (e.g., one bit ‘1’ simplified; bit ‘0’ not simplified ranging). When SS 116 receives the SRI=1, SS 116 performs simplified ranging, such as by only sending a reserved purpose bit in the ranging request. When BS 102 receives such special ranging request, BS 102 only sends an ranging response with one SRI, e.g., one bit ‘1’ successful, ‘0’ failure.

The handover command can include the new FA and cell ID (if applicable) to indicate the change as the target BS FA. BS 102 can include a new field in the command message. The field can be jointly coded with some existing field. For example, if a SHOMI is included, then the field can be included when the SHOMI is valid. SS 116 then can scan for BS 102 (the target BS), and try to re-entry to BS 102 with the simplified re-entry process.

The handover command can include timing information regarding the effective time of the new FA. The timing information can be included in a new field or included in an existing field of handover command. For example, if the handover command contains a field of action time, which is the time for SS 116 to reach the target base station, then the action time can be about or after the effective time for the new FA. Therefore, SS 116 can try to reach the target base station after the serving base station changes FA. In another example, if the handover command contains a field for a ranging initiation deadline, which is the deadline for SS 116 to range the target base station, then the deadline time should be after the effective time for the new FA.

In handover command, the target BSID field can be a special code (e.g., all zeros) configured to indicate a HO to serving BS itself. Alternatively, an indicator can be configured to indicate whether the target BSID is included.

Upon receiving the message, SS 116 decodes the message and finds the effective time of the new FA if included, Then, SS 116 begins to monitor BS 102 (the serving BS) at the new FA (which is the target BS) at, or after, the effective time of the new FA. SS 116 also decodes the new FA information and the new cell ID information in the message and uses new FA information and the new cell ID information to find and monitor BS 102 (the serving BS) at the new FA. SS 116 monitors BS 102 at the new FA, obtains the sync, broadcast channel, where SS 116 obtains the cell ID and BSID of the target BS, and attempts to perform network entry or re-entry. SS 116 also decodes the message and checks whether the indication that target BSID is included or not. If the indication is not included, or SS 116 decodes the special reserved code in target BSID field, SS 116 knows the target BSID may be the serving BSID and that the HO is to handover to the BS 102 itself, then BS 102 can perform simplified network re-entry.

In network re-entry and in ranging request, SS 116 uses a special code (e.g., all zeros) in the field of serving BS to indicate SS 116 is performing HO to the serving BS itself, that is, the target BS (BS 102 at the new configuration) is the same as serving BS (BS 102 at the old configuration). Addition fields that may not be relevant can be omitted.

In the ranging response, BS 102 may only send a field of ranging status. Other fields can be omitted.

BS 102 can send the information (new configuration and effective time, and so forth) of the new configuration to request that SS 116 scan for BS 102 with new configuration, such as in a scan response (such as SCN-RSP), or in a new message.

In some embodiments, BS 102 is an advanced base station (ABS) and SS 116 is an advanced mobile station (AMS). If BS 102, as an ABS, reconfigures FA, BS 102 may also need to reconfigure the Cell ID. Before BS 102 changes its FA, BS 102 sends a message, such as an advanced air interface self organized networks advertisement (AAI_SON-ADV) message, which includes the new FA, an effective time and the in-between time interval occurring between the current configuration, and the new configuration to SS 116. The in-between time interval may become an unavailable interval for SS 116 due to BS 102 transitioning from the current configuration to the new configuration. SS 116 may choose to handover to another BS, such as BS 103, if SS 116 is unable to tolerate the unavailable interval. If the unavailable interval is acceptable for SS 116, SS 116 refrains from sending a signal to the BS 102 during the unavailable interval; although SS 116 can maintain the connection with BS 102.

In some embodiments, when SS 116 is in an idle mode, BS 102 can communicate the configuration and timing information to SS 116. The configuration and timing information can include information regarding the reconfiguration, such as bandwidth change, FA change. The FA change information can include the effective timing for the new FA, bandwidth; new FA, bandwidth; new cell ID if applicable, and so forth. The configuration and timing information can be broadcasted, multicasted or unicasted. In addition, the configuration and timing information can be included in a new message or be added to existing messages.

SS 116 can decode the message that contains the configuration and timing information. SS 116 can decode in its paging listening interval and gets the said information about the reconfiguration.

In the example in FIG. 4, BS 102 begins a base station reconfiguration. In the example shown in FIG. 4, the base station reconfiguration is an FA change; however, the base station can be any type of re-configuration of the base station, such as frequency allocation change, BW change, base station type change, and the like, without departing from the scope of this disclosure.

BS 102 transmits configuration and timing information 405 to SS 116. The configuration and timing information can include FA change information such as the effective timing for the new FA, the new FA, and so forth. The configuration and timing information 405 indicates that the serving base station, BS 102, is also the target base station. The configuration and timing information 405 can be broadcasted, multicasted, or unicasted in a new message or an existing message.

SS 116 identifies that the BSID for the serving base station is the same as the BSID for the target base station. Then, SS 116 transmits a handover (HO) request 410 to BS 102 (the serving base station).

In response to the HO request 410, BS 102 (the serving base station) transmits a HO command 415 to SS 116. SS 116 responds with an HO indication 420. In addition, a handover action time 425 commences at SS 116 in response to receiving the HO command 415.

BS 102 commences the FA change. The FA change can take a certain period of time to complete. The period of time from when BS 102 commences the FA change to when BS 102 completes the FA change can be referred to as the in-between time interval 430. The in-between time interval 430 can be an unavailable interval for SS 116 as a result of BS 102 transitioning from the current configuration to the new configuration. In addition, a ranging initiation deadline 435 duration at BS 102′ (the target base station) can commence.

BS 102′ (the target base station) transmits at the new FA 440, at which SS 116 can monitor. SS 116 decodes the new FA information and the new cell ID information in the message and uses new FA information and the new cell ID information to find and monitor BS 102′ (the target base station) at the new FA. SS 116 monitors BS 102′ (the target base station) at the new FA, transmits a dedicated CDMA ranging code 445. BS 102′ (the target base station) transmits a ranging response Acknowledgement (ACK) 450. BS 102′ (the target base station) transmits encrypted downlink (DL) data, an Uplink (UL) grant, or both, 455 wherein SS 116, in response, transmits encrypted UL data, a bandwidth (BW) request, or both, 460. SS 116 also transmits a ranging request 465. In response, BS 102′ (the target base station) transmits a ranging response 470.

In some embodiments, in the network re-entry and ranging request, SS 116 can use a special code (e.g., all zeros) in the field of serving BS to indicate SS 116 is performing HO to the serving BS itself, that is, the target BS (BS 102 at the new configuration) is the same as serving BS (BS 102 at the old configuration). Therefore, some fields or signals that may not be relevant can be omitted. For example, one or more of the following may be omitted: the HO request 410, the HO indication 420, the transmission of the new FA 440, the transmission of the dedicated ranging code 445, the transmission of the ranging response ACK 450, the encrypted DL data and/or UL grant 455, and the encrypted UL data and/or BW request 460.

In the simple HO, BS 102 transmits configuration and timing information 405 to SS 116. The configuration and timing information can include FA change information such as the effective timing for the new FA bandwidth, new FA bandwidth, and so forth. The configuration and timing information 405 indicates that the serving base station, BS 102, is also the target base station. The configuration and timing information 405 can be broadcasted, multicasted, or unicasted in a new message or an existing message.

In some embodiments, BS 102 (the serving base station) transmits a HO command 415 to SS 116. Then, BS 102 commences the FA change. The FA change can take a certain period of time to complete. The period of time from when BS 102 commences the FA change to when BS 102 completes the FA change can be referred to as the in-between time interval 430. The in-between time interval 430 can be an unavailable interval for SS 116 as a result of BS 102 transitioning from the current configuration to the new configuration. In addition, a ranging initiation deadline 435 duration at BS 102′ (the target base station) can commence. Then, prior to termination of the ranging initiation deadline 435, SS 116 can transmit a ranging request 465. In response, BS 102′ (the target base station) transmits a ranging response 470.

In some embodiments, BS 102 can send SS 116 reconfiguration information for BS 103. The reconfiguration information can include a bandwidth change, FA change (such as the effective timing for the new FA, and so forth; new FA, bandwidth, and so forth; and new cell ID if applicable). The reconfiguration information can be broadcasted, multicasted, or unicasted, in a new message or can be added to the existing message, such as neighbor advertisement message NBR-ADV, scan response SCN-RSP message, and the like. SS 116 can receive the reconfiguration information by decoding the message.

FIG. 5 illustrates an operation for a femto base station to transition between a regular mode and a relay mode according to embodiments of the present disclosure. The embodiment of the operation 500 shown in FIG. 5 is for illustration only. Other embodiments could be used without departing from the scope of this disclosure.

In some embodiments, FBS 160 can include both a regular mode 505 and a relay mode 510. The regular mode 505 can be the default mode. When the backhaul connection in the regular mode 505 is disconnected, FBS 160 operates in relay mode 510, in which FBS 160 communicates with other base stations, such as BS 102 and BS 103, over the air.

In some embodiments, FBS 106 uses a mode indicator to indicate whether the regular mode 505 or the relay mode 510 is used. The mode indicator can be a single bit in a preamble sequence, where the preamble sequence is the sequence used for synchronization. The mode indicator also can be indicated by partitioning the preamble sequence such that one partition is used for the regular mode 505 and another partition is used for the relay mode 510. The mode indicator also can be one bit in the broadcast control channel, such as in the superframe header. The mode indicator also can be a scrambling sequence to the CRC of superframe header, with one sequence indicating regular mode 505, another sequence indicating relay mode 510.

In some embodiments, FBS 160 can determine that the backhaul connection is failing or otherwise will be lost. Prior to FBS 160 switching from the regular mode 505 to the relay mode 510, FBS 160 can send switch message 515 to SS 116. The switch message 515 is configured to inform SS 116 that FBS 160 will be operating in the relay mode 510. The switch message 515 can be configured to inform SS 116 regarding the time at which the relay mode 510 will be effective. The switch message 515 includes a field for the mode indicator and a field for the timing at which the mode will be effective. The switch message 515 also can include some system information to be used in the relay mode 510, such as the preamble sequence, relay frame structure type, and so forth.

When the backhaul connection has been restored, FBS 160 can return to the regular mode 505. FBS 160 can switch back to the regular mode 505 from the relay mode 510. Prior to exiting the relay mode 510, FBS 160 sends a switchback message 520 to SS 116 to inform SS 116 regarding the timing and the configuration of the regular mode 505, such as the preamble sequence, and so forth.

In some embodiments, the relevant system information and configurations, which will be changed as a result of FBS 160 changing modes, and the timing of the actual change, are sent prior to the actual change. Therefore, SS 116 is provided sufficient time to receive the new configuration of the femtocells and prepare for the mode change. The system information and configuration information relevant to the femtocell type change may include, the cell ID, or the preambles, information in super frequency header (SFH) and so forth.

In some embodiments a mode message, such as the switch message 515 or switchback message 520, which are used to indicate the Femto-Mode-Change, can include the system information/configuration relevant to the femtocell type change and the timing of the actual change. The mode message 515, 520 can be transmitted as separate message or included as part of another message. The mode message 515, 520 also may be carried in broadcast channel such as the SFH, extended information, system configuration, and the like. The mode message 515, 520 can be sent in as a unicast, multicast or broadcast message.

The timing of the actual change may be set based on an Idle-mode-cycle of SS 116. For example, the time between the first mode message, such as the switch message 515, and the actual change can be equal to or longer than the Idle-mode-cycle of SS 116. Therefore, SS 116, which is in idle mode, can learn about the change prior to the actual change and adjust itself, such as by monitoring the femtocell with a given Cell ID (preamble) after the indicated timing.

In some embodiments, one or multiple transition frames can contain multiple repeated mode messages 515, 520. Alternatively, one or more new sync channels, broadcast channels, or other downlink channels can be repeatedly sent in the transition frames.

Prior to the femtocell type change, FBS 160 can request that the subscriber stations in its coverage conduct a handover to BS 102 or BS 103. The system information and configuration information relevant to the femtocell type change and the timing of the actual change may be alternatively sent in the handover command from FBS 160 to the subscriber stations, such as SS 116. A handover action time field can be included in the handover command. The handover action time could be the time of the actual change of femto type or the time after.

Prior to the femtocell type change, FBS 160 may ask the subscriber stations in its coverage area to handover to itself using a much simplified network re-entry process. FBS 160 can send the subscriber stations, such as SS 116, a HO command, which indicates the new system information related to the mode to which FBS 1660 will switch. The new system information can include a Cell ID, frame structure, and so forth. In the HO command, a purpose indicator can be used for femtocell mode switching. The purpose indicator can be configured to indicate the purpose of the handover. Upon receiving the HO command, SS 116 can decode the purpose indicator, when included, perform a much simplified network re-entry since all the MAC, such as station ID, flow ID, and so forth. can be the same. There may be no need for authentication, or the like. The ranging process may even be omitted or simplified. FBS 160 can instruct SS 116 to adjust its power, time, frequency, and so forth, via messages related to network re-entry, such as via ranging response, and the like. It will be understood that although mode change is illustrated as an example, the reconfiguration can be any kind of any femto base station re-configuration, such as frequency allocation change, BW change, base station type change, and the like without departing from the scope of this disclosure.

In some embodiments, FBS 160 can reserve some resource such as preamble (cell ID) in when a mode switch occurs between the regular mode 505 and the relay mode 510. The resource, such as preamble (Cell ID), also can be dynamically selected when it is needed.

In some embodiments, SS 116 can request to handover to femtocells using the FA and cell ID and other identifiers. The serving BS, such as FBS 160, can command SS 116 to handover to the femto with indicated FA, cell ID, and other identifiers, so that SS 116 can quickly find the femtocell.

In some embodiments, the MAC is maintained (remains the same) for different mode. For example, station ID (STID), the flow ID, and the like can be maintained as the same.

In some embodiments, a reconfiguration message about the reconfiguration can be sent to SS 116. The reconfiguration message can include the timing information on the unavailable interval in which the BS 102, or some portion or configuration of the BS 102, is not available due to the reconfiguration. For example, the timing information can be the unavailable interval starting time and an unavailable time interval length. Alternatively, the timing information can be the unavailable interval starting time and unavailable interval ending time. The reconfiguration message also can include the new configuration. The starting time of the unavailable interval can be the time of the expiration of the current configuration of BS 102. The ending time of the unavailable interval can be the effective time of the new configuration of BS 102. The unavailable interval can be the duration of the transition period, or the reconfiguring period, that BS 102 requires to change the configuration. If the reconfiguration does not require a transition period from stopping the current configuration and effecting the new configuration, then the reconfiguration message may not need to include the timing information about the interval; rather, the reconfiguration message can include the effective time of the new configuration and the new configuration itself. The reconfiguration message can be sent to SS 116 prior to the effective time of the new configuration or prior to the expiration of the current configuration, if applicable. The reconfiguration message can be sent aperiodically or periodically. BS 102 can hold, keep or store, the MAC context, security context, subscriber station basic capabilities, subscriber station security capabilities, and so forth, about SS 116.

When SS 116 receives the reconfiguration message, SS 116 can cache or store the MAC context, security context, basic capabilities, and so forth. SS 116 can request a handover or request a network re-entry to BS 102, that is, the base station that sent the reconfiguration message. SS 116 can send a ranging request message to BS 102, to request a re-entry.

SS 116 can perform a simplified network re-entry, or an optimized network re-entry, by using a re-entry process optimization. SS 116 may include the cipher-based message authentication code (CMAC), or some security related context, in the ranging request (RNG-REQ) message.

When BS 102 receives the ranging request message from SS 116, BS 102 can recognize that SS 116 is eligible to perform optimized re-entry based on the information cached. Then, BS 102 can send a ranging response message to SS 116. In the ranging response (RNG-RSP) message, BS 102 can indicate how the re-entry process can be optimized, such as, whether to omit the SBC (basic capability) request/response (REQ/RSP) MAC control messages; whether to omit the PKM authentication phase; whether to omit the registration request/response (REG-REQ/RSP) message and higher layer protocol triggering; whether the full service and operational state was transferred or shared. BS 102 can set the indications to: Omit SBC-REQ/RSP MAC control messages, Omit PKM Authentication phase, Omit AAI_REG-REQ/RSP message and higher layer protocol triggering, Full service and operational state was transferred or shared.

Upon receiving the ranging response, SS 116 can perform the network re-entry process according to the indications in the ranging response.

BS 102 also can instruct SS 116 to perform a handover, or network re-entry, due to the reconfiguration. BS 102 can send a handover command (HO-CMD) message to SS 116. The HO-CMD message can reflect the BS reconfiguration timing, new configurations, and so forth. For example, HO-CMD can indicate that SS 116 set: the ‘disconnection time’ to be around the time of the expiration time of the current configuration of BS 102; the ‘action time’ to be around the time of the effective time of the new configuration of BS 102; the ‘BS ID of the target base station’ to be the same as the BS ID of BS 102, the ‘cell ID of the target base station’ to be the new cell ID if applicable; the ‘FA of the target BS’ to the new FA of BS 102 if applicable, and so forth. BS 102 can hold, keep or otherwise store, the MAC context, security context, subscriber station basic capabilities, subscriber station security capabilities, and the like, about SS 116.

Upon receiving the HO-CMD, SS 116 can perform a handover or a network re-entry to the same BS, e.g., BS 102. SS 116 can cache or store the MAC context, security context, basic capabilities, and the like. SS 116 can send a ranging request message to BS 102 to attempt re-entry to BS 102. SS 116 can perform a simplified network re-entry, or an optimized network re-entry. BS 102 can instruct SS 116 on how the network re-entry will be optimized by indications in ranging response message. The procedure is similar to the one described herein above.

The procedures can be combined and can be applicable to any reconfigurations. For example, the process can apply to reconfiguring the carrier frequency or frequency allocation, the cell ID or the preamble of the base station, and so forth.

The embodiments can also be applied to the case that BS needs to restart because of reconfiguration. In this case, the effective time of the new configuration will be sometime after the restart. For example, the handover command can set the action time as the time of the new configuration taking into account the restart.

In some embodiments, when the system is according to IEEE 802.16m, and when BS 102 is an ABS and SS 116 is an AMS, when BS 102 reconfigures FA, BS 102 may also need to reconfigure Cell ID. Before BS 102 changes its FA, BS 102 can send an AAI_SON-ADV message to SS 116, which is in the coverage area of BS 102. The AAI_SON-ADV message can include the new FA, an effective time for the FA, and the in-between time interval between the current configuration and the new configuration. The in-between time interval can be an unavailable interval for SS 116 as a result of BS 102 transitioning from the current configuration to the new configuration. SS 116 can choose to handover to another base station, such as BS 103, if SS 116 cannot tolerate the unavailable interval. When the unavailable interval is acceptable to SS 116, SS 116 can refrain from transmitting any signal to BS 102 during the unavailable interval; although SS 116 can maintain the connection with BS 102. SS 116 can request to HO to BS 102 (the serving ABS) itself at the new FA. BS 102 can command SS 116, to handover to BS 102 (itself) at the new FA. The MAC context, such as station ID, connection ID, and so forth, remains the same, to enable SS 116 to perform a simplified network re-entry. BS 102 can inform SS 116 about the new FA and the new cell ID, if applicable, (as the target ABS FA, target ABS cell ID) in AAI_HO-CMD, and set the action time in AAI_HO-CMD to be no sooner than the effective time of new FA.

For example, when BS 102, as the serving base station, commands SS 116 to handover to BS 102 (e.g., itself), the following occurs:

BS 102 commands SS 116 to handover to itself

1) MAC context remains the same;
2) Simplified HO procedure:

a) About target BSID
i. [option 1] Using existing HO procedure—In HO-CMD, target BSID is the same as the BSID of serving BS.
ii. [option 2] Indicate a special HO mode ‘11’ in HO-CMD, which is for SS 116 to handover to BS 102 (the serving BS) itself. If the mode is ‘11’, no target BSID is needed. This saves 48 bit BSID transmission.
iii. [option 3] In the HO-CMD, in the field of target BSID, BS 102 inserts a special code (such as, all zeros), to indicate it is for HO to BS 102 (the serving BS) itself.

b) Simplified Re-entry. The ranging may not be needed. The HO-CMD includes a new bit that indicates whether the ranging (RNG-REQ, RNG-RSP) can be skipped. ‘1’ Not skip; ‘0’ Skip.

c) About the FA that BS 102 will switch to:
i. [option 1] The field ‘Physical_Carrier_Index’ in the current HO-CMD can be used to indicate the FA to which BS 102 will switch.
ii. [Option 2] The HO-CMD can include a field “FA of the target BS”. In some embodiments, this is jointly used with the option 2 (e.g., indicating a special HO mode ‘11’ in HO-CMD) above.

If the mode is ‘11’, a field of FA of the target BS will be used, otherwise, no such field included.

d) The action time in HO-CMD can be approximately the effective time for the new FA.

BS 102 broadcasts information regarding the FA change in order to enable SS 116 to prepare for the FA change:

1) The SON-ADV message is configured to include:

a) Timing for the FA change;

b) ii. The New FA; and

c) The New cell ID (if applicable).

2) SS 116 performs prepared, simplified HO:

a) BS 102 can add itself with the new FA to the NBR-ADV (may add a timing tag on this entry); and

b) SS 116 can HO to BS 102 (the serving BS) itself or SS 116 can HO to BS 103 (e.g., another BS).

Therefore, SS 116 has an open option to choose whether to HO to the serving BS (BS 102) itself or HO to another BS (BS 103).

In some embodiments, when at least one of the base stations is a femtocell base station, such as FBS 160, BS 102 can:

1) BS 102, which can be an ABS, can ask its subscriber stations to HO to itself at a different FA. BS 102 maintains the context of the connection, such as STID, MS MAC ID, and so forth;
2) indicate that a simplified handover for SS 116 to handover to BS 102 (the serving base station) itself can be performed by:

a) In the HO-CMD, BS 102 indicates the new FA in a new field, or in the field ‘Physical_Carrier_Index’;

b) In the field for the target BSID in the HO-CMD, BS 102 inserts a special code (such as all zeros), to indicate that the HO will be to itself;

c) For the network re-entry, in the RNG-REQ, SS 116 uses a special code (such as all zeros) in the field for the serving BS to indicate it is performing HO to the serving BS itself, that is, the target BS is the same as serving BS. One or more irrelevant fields can be omitted; and

d) In RNG-RSP, BS 102 can send only a field for ranging status and omit the remaining fields.

BS 102 can broadcast SON-ADV if its FA changes. The simplified handover for SS 116 to handover to the serving base station itself then can be performed.

In some embodiments, when using a ‘Reentry Process Optimization’ field, one or more messages are configured as follows:

1) The SON-ADV message is configured to indicate the ‘Unavailable start time/Unavailable Time Interval’ and new Cell ID;
2) The HO-CMD message is configured to set ‘Action/Disconnect Time’, ‘BS ID’, ‘Cell ID’ based on the SON-ADV message;
3) The RNG-RSP is configured to include in indication for reentry optimization such that, upon reception of the RNG-REQ, BS 102 transmits the RNG-RSP with ‘Reentry Process Optimization’ field. The Reentry Process optimization' field can indicate an omission of following procedures:

a) Bit #0: Omit the basic capability negotiation procedure, such as omit the basic capability negotiation request and response (e.g., AAI_SBC-REQ/RSP) MAC control messages;

b) Bit #1: Omit the private key MAC (PKM) control messages and PKM Authentication phase;

c) Bit #2: Omit the registration procedure such as omit the registration request and response messages (e.g., AAI_REG-REQ/RSP message) and higher layer protocol triggering; and

d) Bit #3: Full service and operational state was transferred or shared, or kept.

In addition, in SON reconfiguration case, ‘Reentry Process optimization’ could be set to ‘0b1111’. Therefore, the Reentry Process optimization’ in the AAI_RNG-RSP message can be set to ‘0b1111’ during SON reconfiguration.

The MS, the BS, and the network can keep the communication context, such as the security context, basic capability context, MAC context, higher layer communication such as service related context, operational state context, etc. The kept communication context can enable or help the simplified or optimized network re-entry.

In some embodiments, before BS changes its configuration (such as FA, bandwidth, BS type, etc.), may send AAI_SON-ADV message which includes the current configuration (such as FA, bandwidth, BS type, etc.) downtime, new configuration (such as FA, bandwidth, BS type, etc.) and its up time to AMS. The AMS may perform network re-entry into the same ABS, at the new FA uptime and continue with its session.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. For use in a wireless communications network, a base station capable of communicating with a plurality of subscriber stations, the base station comprising:
a transmit path configured to transmit a message to at least one subscriber station; and
a controller coupled to the transmit path and configured to, prior to a change of at least one parameter, inform the at least one subscriber station regarding the change of the at least one parameter via the message, the message comprising information regarding the change of the at least one parameter, the information configured to enable the subscriber station to perform a network re-entry.

2. The base station as set forth in claim 1, wherein the message includes at least one of:
a change start time configured to indicate when the change of the at least one parameter will commence;
a change completion time configured to indicate when the change of the at least one parameter will be completed such that the base station will be operating at a new setting of the at least one parameter;
a time interval occurring between the change start time and the change complete time;
the new setting of the at least one parameter, wherein the at least one parameter comprises at least one of:
a frequency allocation;
a bandwidth;
a normal mode; and
a relay mode.

3. The base station as set forth in claim 1, wherein the message is configured to enable the at least one subscriber station to at least one of: handover and perform network reentry from the base station to the base station with a new setting of the at least one parameter.

4. The base station as set forth in claim 1, wherein the transmit path transmits the message as one of:
a broadcast message;
a multicast message; and
a unicast message.

5. The base station as set forth in claim 1, the controller is configured to maintain the communication context and indicate a network reentry process optimization to simplify the network reentry, wherein the network reentry is configured to omit at least one of the following procedures:
a basic capability negotiation procedure;
authentication phase;
registration messages and higher layer protocol triggering; and
full service and operational state was transferred or shared.

6. The base station as set forth in claim 1, wherein the network re-entry is performed in at least one of:
concurrently when the at least one parameter is changed; and
after the change to the at least one parameter is effective.

7. For use in a wireless communications network, a method for reconfiguring a base station, the method comprising:
prior to changing a configuration of the base station, sending a message to at least one subscriber station, the message configured to indicate a change to at least one parameter; and
enabling the at least one subscriber station perform a network re-entry.

8. The method as set forth in claim 7, wherein sending the message comprises including in the message at least one of:
a change start time configured to indicate when the change of the at least one parameter will commence;
a change completion time configured to indicate when the change of the at least one parameter will be completed such that the base station will be operating at a new setting of the at least one parameter;
a time interval occurring between the change start time and the change complete time;
the new setting of the at least one parameter, wherein the at least one parameter comprises at least one of:
a frequency allocation;
a bandwidth;
a normal mode; and
a relay mode.

9. The method as set forth in claim 7, wherein enabling comprises enabling the at least one subscriber station to at least one of: handover and perform network reentry from the base station to the base station with a new setting of the at least one parameter.

10. The method as set forth in claim 7, sending the message comprises one of:
a broadcasting the message;
a multicasting the message; and
unicasting the message

11. The method as set forth in claim 7, further comprising maintaining the communication context and indicating a network reentry process optimization to simplify the network reentry, wherein the network reentry is configured to omit at least one of the following procedures:
a basic capability negotiation procedure;
authentication phase;
registration messages and higher layer protocol triggering; and
full service and operational state was transferred or shared.

12. The method as set forth in claim 7, wherein the network re-entry is performed in at least one of:
concurrently when the at least one parameter is changed; and
after the change to the at least one parameter is effective.

13. For use in a wireless communications network, a subscriber station capable of communicating with a plurality of base stations, the subscriber station comprising:
a receiver configured to receive a plurality of messages from a base station; and
a controller coupled to the receiver and configured to decode a message received prior to a change of at least one parameter of the base station, the message comprising information regarding the change of the at least one parameter, wherein the controller is configured to obtain, from the message, the information regarding the change of the at least one parameter, the information configured to enable the subscriber station to perform a network re-entry.

14. The subscriber station as set forth in claim 13, wherein the message includes at least one of:
a change start time configured to indicate when the change of the at least one parameter will commence;
a change completion time configured to indicate when the change of the at least one parameter will be completed such that the base station will be operating at a new setting of the at least one parameter;
a time interval occurring between the change start time and the change complete time; and
the new setting of the at least one parameter, wherein the at least one parameter comprises at least one of:
a frequency allocation;
a bandwidth;
a normal mode; and
a relay mode.

15. The subscriber station as set forth in claim 13, wherein the message is configured to enable the subscriber station to at least one of: handover and perform network reentry from the base station to the base station with a new setting of the at least one parameter

16. The subscriber station as set forth in claim 13, wherein the receiver is configured to receive the message as one of:
a broadcast message;
a multicast message; and
a unicast message.

17. The subscriber station as set forth in claim 13, the controller is configured to maintain the communication context and perform the network reentry, wherein the network reentry is configured to omit at least one of the following procedures:
a basic capability negotiation procedure;
authentication phase;
registration messages and higher layer protocol triggering; and
full service and operational state was transferred or shared.

18. The subscriber station as set forth in claim 13, wherein the network re-entry is performed in at least one of:
concurrently when the at least one parameter is changed; and
after the change to the at least one parameter is effective.

19. For use in a wireless communications network, a method for operating a subscriber station, the method comprising:
prior to changing a configuration of a base station, receiving a message from the base station, the message comprising information regarding the change of the at least one parameter; and
obtaining, from the message, the information regarding the change of the at least one parameter to enable the subscriber station to perform a network re-entry.

20. The method as set forth in claim 19, wherein receiving the message comprises obtaining from the message at least one of:
a change start time configured to indicate when the change of the at least one parameter will commence;
a change completion time configured to indicate when the change of the at least one parameter will be completed such that the base station will be operating at a new setting of the at least one parameter;
a time interval occurring between the change start time and the change complete time;
the new setting of the at least one parameter, wherein the at least one parameter comprises at least one of:
a frequency allocation;
a bandwidth;
a normal mode; and
a relay mode.

21. The method as set forth in claim 19, wherein the message is configured to enable the subscriber station to at least one of: handover and perform network reentry from the base station to the base station with a new setting of the at least one parameter.

22. The method as set forth in claim 19, receiving the message comprises receiving the message as one of:
a broadcast message;
a multicast message; and
a unicast message

23. The method as set forth in claim 19, further comprising maintaining the communication context and performing the network reentry, wherein the network reentry is configured to omit at least one of the following procedures:
a basic capability negotiation procedure;
authentication phase;
registration messages and higher layer protocol triggering; and
full service and operational state was transferred or shared.

24. The method as set forth in claim 19, further comprising performing the network re-entry in at least one of:
concurrently when the at least one parameter is changed; and
after the change to the at least one parameter is effective.
